(19) United States
(12) Patent Application Publication
(10) Pub. No.: US 2012/0158543 A1
(43) Pub. Date: Jun. 21, 2012

(54) Ordering system with terminal unit using a wireless network

(75) Inventors: Jesper Buch, London (GB); Kristian Erbou, Vejle (DK)

(73) Assignee: Tiger Moth Ltd., Gibraltar (GI)

(21) Appl. No.: 11/922,191

(22) PCT Filed: Jun. 16, 2006
(86) PCT No.: PCT/DK2006/000346

§ 371 Date: Feb. 20, 2008

(30) Foreign Application Priority Data
Jun. 16, 2005 (EP) 05012990.7

(51) Int. Cl. G06Q 30/00

(52) U.S. Cl. 705/26.61

(57) ABSTRACT

An ordering system for ordering services or goods, the ordering system comprising
a plurality of client computers (8) connected to a digital data network (9), the client computers (8) comprising means for receiving input from a client concerning orders,
a central server system comprising a first software program (1) and being connected to a first database (15) and to the digital data network (9), the first database (15) comprising digital data representing information about services or goods, service providers or good providers, the first software program (1) being configured for communication with the client computers (8) through the digital data network (9) for providing data from the first database (15) to the client computers (8) concerning offers for services or goods and for receiving digital data representing the orders for the services or goods, the first software program (1) being programmed to transmit an order to a service provider or goods provider in dependence of the order from a client,
at least one terminal unit (2) at the site for the service provider or good provider, the terminal unit (2) being configured for receiving orders from the first software program (1) and having means (10) for indicating the requested orders to the service or goods provider,
a wireless digital data network (7) for transmitting data between the first software program (1) and the terminal unit (2) through a non-dedicated wireless line.

### FIELD OF THE INVENTION

The present invention relates to an Internet ordering systems for services or goods with a central server system and corresponding terminal units at the vendors site, especially for take-away restaurants.

### BACKGROUND OF THE INVENTION

In connection with take-away restaurants, ordering systems exist, where the user may order food over the Internet and receive as a response an indication, whether the actual restaurant is able to have the ordered food ready within reasonable time and when the food can be picked up or delivered.

An ordering system is disclosed in U.S. Pat. No. 5,991,739 by Cupps et al., where an order from the client is converted by a server into a voice instruction to the vendor or into instructions by e-mail, telephone or as a facsimile transmission.

In order to assure that the vendor receives communication undisturbed from such a server, an ordering system is disclosed in International patent application WO 02/37347 by Berno, where the ordering is performed through a dedicated connection from a server. This system is used in Denmark for take-away restaurants, but has some disadvantages as explained in the following. In order for the system to operate, each restaurant needs a dedicated line, such as an ISDN line (Integrated Services Digital. Network) or an ADSL line (Asymmetric Digital Subscriber Line). For a restaurant owner, a participation in such an ordering system may take substantial time, if such a dedicated line does not exist, because several weeks may pass, before such a line is installed in the restaurant by the right technical personnel. Furthermore, the configuration of the terminal unit, which is used for indicating an order to the vendor and for communication to the central server and the client, has to be configured correctly by a technician before use, which implies that the terminal unit has to be sent to a technician or the technician has to visit the restaurant. This is also the case, when changes have to be made to the configuration of the terminal unit after a certain time of use. The change of configuration may induce substantial costs.

### DESCRIPTION/SUMMARY OF THE INVENTION

It is therefore the purpose of the invention to provide a different system not having the above disadvantages. In particular, it is the purpose of the invention to provide a system where installation and maintenance of terminals at the vendor's site is facilitated.

This purpose is achieved with an ordering system for ordering services or goods, the ordering system comprising
a plurality of client computers connected to a digital data network, the client computers comprising means for receiving input from a client concerning orders,
a central server system comprising a first software program and being connected to a first database and to the digital data network, the first database comprising digital data representing information about services or goods, service providers or good providers, the first software program being configured for communication with the client computers through the digital data network for providing data from the first database to the client computers concerning offers for services or goods and for receiving digital data representing the orders for the services or goods, the first software program being programmed to transmit an order to a service provider or goods provider in dependence of the order from a client,
at least one terminal unit at the site for the service provider or good provider, the terminal unit being configured for receiving orders from the first software program and having means for indicating the requested orders to the service or goods provider,
a wireless digital data network for transmitting data between the first software program and the terminal unit through a non-dedicated wireless line.

The system according to the invention may be used for ordering services or goods the way as it is known for existing systems, where an ordering is performed over the Internet, for example on an Internet site, and services are picked up or delivered at the correct address. Examples for such Internet ordering is disclosed in the documents cited in the introduction above, or on the Internet portal www.just-eat.com and www.just-eat.dk.

As the data between the central server system and the terminal unit are transmitted wireless, no installation of a dedicated line, such as a ISDN or ADSL is necessary. Also, the relatively high costs of such lines are avoided.

Preferably, the data network is the Internet and the wireless digital data network is GPRS network. A network provider may be connected to the servers via the Internet and receive messages from the servers in order to forward these via the wireless network, for example the GPRS, to the terminal unit. In addition, the network provider receives messages from the terminal unit via the wireless network and transmits these via the Internet to the respective servers.

In order to facilitate the installation of the terminal unit as much as possible, the terminal unit may be programmed to automatically search for a wireless data network and attempt to connect to a central server system upon powering on. The necessary network log-on information and server address may be stored in the memory of the terminal unit. Alternatively, in order for this automatic search to be performed, the terminal unit may be programmed to await a data message, preferably an SMS message, with access information such as an Access Point Name (ANP) for logging onto the wireless network and with server address information for contacting the correct server. Optionally, the terminal unit may store these settings and be programmed to shut down and then log-on to the wireless network with these stored new settings.

In addition, the terminal unit may be programmed to automatically request configuration data from the server system after connection to the wireless data network and may be configured for performing a configuration for the actual functioning of the terminal unit as a result of the receipt of configuration data. This embodiment is a further very advantageous improvement. The data transmission capacity of the GPRS network is suited for data transmission to an extent which allows a complete configuration of the terminal unit.

The terminal unit, for convenience later in short called box due to the typical appearance of such a terminal unit, at the site of the vendor selling services, food or other goods, has been developed to simplify and minimise all actions that are necessary from the vendor's site. The vendor does not need any technician for set-up, because the terminal unit upon a simple power-on performs all the steps in collaboration with the GPRS network and the involved servers in order to start functioning. As not only the connection to the network is performed automatically but also the receipt of functions, for example the language, the performance routines, a terminal unit according to the invention is universal such that it can be used in different countries with different languages and for different service providers or vendors.

New terminal units for new providers can easily be added to the system as well as terminal units can be removed. All control with the boxes is at the server's site.

For example, the configuration data may include one or more of the following,
an indication for the language of text to be indicated on a display of the terminal unit as a response to an order receipt,
configuration of the terminal unit for receipt and print of a daily order list in accordance with daily opening hours of the service or goods provider,
configuration of the terminal unit to send an SMS to the ordering client for confirmation of the order, optionally the SMS including delivery time or pick-up time and price,
configuration of a menu structure for a user menu associated with a display of the terminal unit,
configuration of graphics for a display of the terminal unit. Many other kinds of configuration may be included.

In a practical embodiment, the ordering system has been configured with a three-tier client-server structure. More concrete, the three tier client structure may imply
at least one terminal unit connectable to a wireless network,
a first server or first group of servers with a first software program programmed to provide information to clients, to receive orders from the clients for services or goods, and to transmit the orders to the terminal unit and programmed to receive messages from the terminal unit concerning possible execution of the order,
a second server or a second group of servers with a second software program configured to receive the orders through the digital data network from the first server or first group of servers with the first software program, the second server or the second group of servers being connected through a mobile network provider to the wireless data network and configured by the second software program to transmit theses orders through the wireless network to the terminal unit, the second server or second group of servers also being configured to receive messages from the terminal unit through the wireless network and forwarding these messages to the first software program on the first server or first group of servers.

The first server or first group of servers may comprise a number of servers in a number of countries with at least one server in each country.

As will be apparent below, advantageously, a server system according to the invention may be configured such that only the second software program on the second server or second group of servers has access to a second central database that contains information of and for all the registered terminal units.

Thus, whereas the first database connected to the first server or group of severs contains all the information about the service providers or goods providers and the services or goods that are presented to a potential client, the second database contains all the information about the terminal units connected to the system and the commands and information that is actually sent to the terminal units.

For safety reasons and for proper functioning, the server system may have a surveillance routine, which is programmed to restart at least parts of the system upon breakdown of the system and which is programmed to store a failure report in a log-file in the central database

For Internet communication, the first server or first group of servers and the second server or second group of servers are advantageously configured to use Extended Markup Language (XML) for communication over the digital data network, optionally implying Simple Object Access Protocol (SOAP).

Each terminal unit may have an unchangeable ID in order to recognise the terminal unit in the system. This ID is related to the GPRS unit located in the box and predetermined by the manufacturer of the box. This ID corresponds to the MAC-identification code associated with an Ethernet network card—the standard network card used in personal computers today.

A number of examples of applications illustrate the advantages of the present invention.

### Example 1

In a restaurant, where the terminal unit is used for ordering tables, difficulties are experienced in the personnel not reading the printed or displayed message thoroughly, such that the customers often get smoker tables even though they ordered non-smoker tables. The solution may be the terminal unit being configured via the wireless data network to play a certain melody in dependence of wanted smoker or non-smoker tables.

### Example 2

A taxi agency needs a daily report for the number of customers who have ordered cars through the terminal unit. The solution may be that the terminal unit is configured via the wireless data network to send a request to the server for receipt of a daily report, which then is printed through the terminal unit at the end of the day.

### Example 3

A pizzeria receiving food orders through the terminal unit may as well use the terminal unit to order new pizza wrappers or additional beverage bottles because it is possible to configure the terminal unit via the wireless data network to send a message to a Business-to-business delivery service. It is possible to configure a menu structure through which a user can “paddle” and in the end submit an order of, for example, 10 soda cases delivered on the Jun. 31, 2005 at 10 PM. This message will in all cases be sent to the BoxHandlerService which then is responsible to forward the order to the responsible staff at the supplier service.

### Example 4

The terminal unit may be configured to send an SMS to the ordering client as a confirmation of the receipt of the order. The user of the terminal unit in the restaurant may not be involved in the process, as the terminal unit may be configured via the wireless data network to do this automatically.

### Example 5

The shop or restaurant using the terminal unit may through the server get a service, where a whole day's orders and related information such as prices at the end of the day is transmitted to the terminal unit via the wireless data network and printed on the printer that is connected to the terminal unit. The closing hours of the shop or restaurant may be stored in the first database of the server system with the CountryHandlerService associated with this terminal unit.

As a summary, the following should be noted. The terminal unit is an autonomous unit that is able to connect to a GPRS network or likewise wireless data network with sufficient bandwidth for the data transmission, connect to a server, receive and perform the commands from the software server. The terminal unit is configured to maintain the connection. If the terminal unit is not able to maintain the connection, for example due to a network failure or a server breakdown, a new log-on can be initiated by sending an SMS or other kinds of commands to the terminal unit with a server address after reestablishment of the function in the network or server.

The content of an SMS does not force the terminal unit to initiate the logon procedure. The SMS contains setting data indicating where to logon, which password and username to give to the GPRS network and possibly other data. It is implemented in the business logic of updating particular settings that after being saved in memory, the terminal unit should reboot and use the new settings provided.

### SHORT DESCRIPTION OF THE DRAWINGS

The invention will be explained in more detail with reference to the drawing, where

FIG. 1 is a sketch illustrating the principle of the invention,

FIG. 2 is a deployment diagram for the principle of the invention,

FIG. 3 is a diagram showing the log-on procedure of a terminal unit,

FIG. 4 is a sequence diagram illustrating the sequence for transmission of data,

FIG. 5 illustrates a possible embodiment of a terminal unit in the form of a box,

FIG. 6 illustrates the order flow from the perspective of the user.

### DETAILED DESCRIPTION/PREFERRED EMBODIMENT

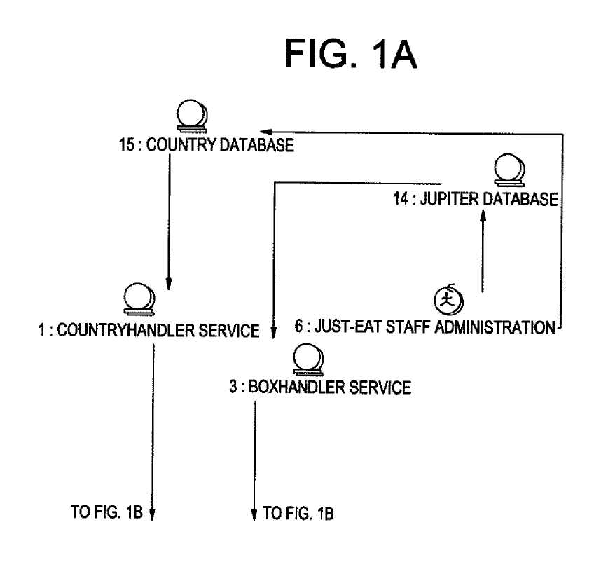

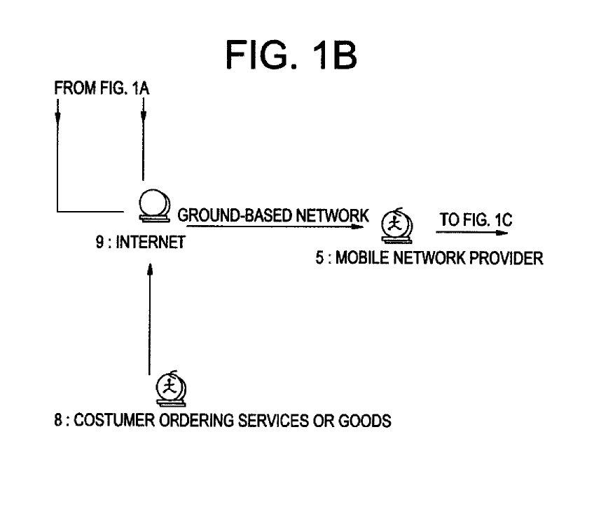

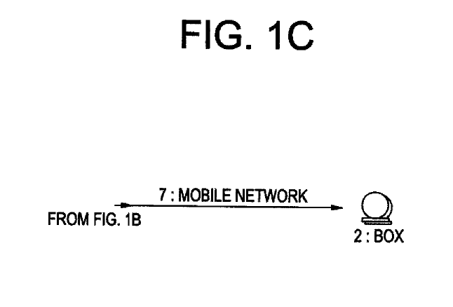

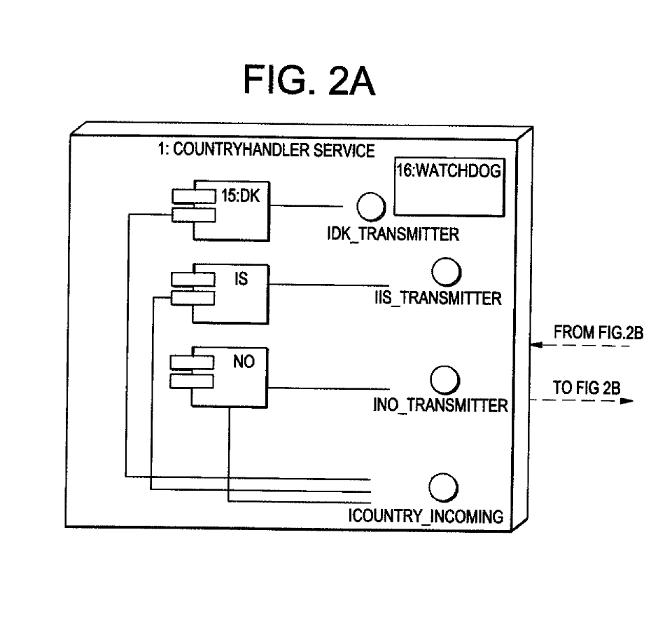

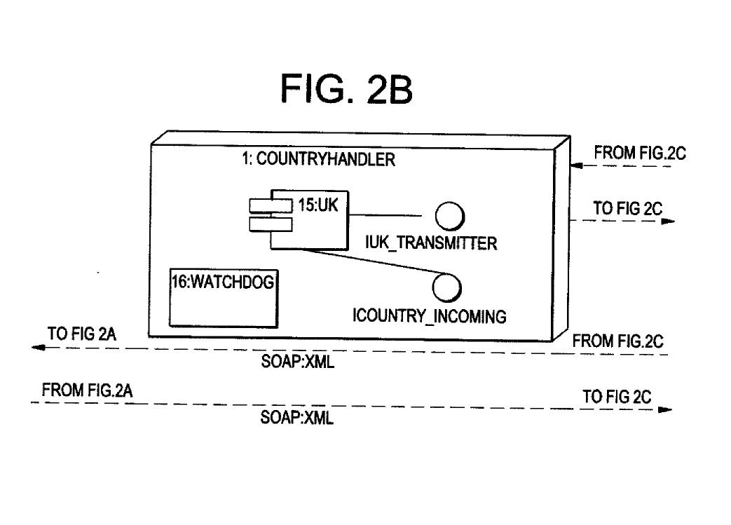

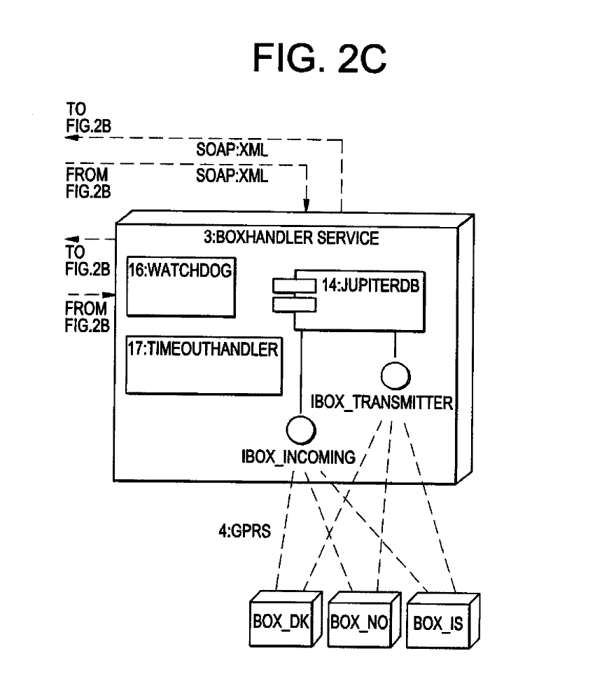

The principle of the invention is explained in FIG. 1. A number of client computers 8 are connected to the Internet 9 and may via the Internet access an Internet site for receiving information from a first database 15 connected to one or more servers running a first software program, the CountryHandlerService 1, where the information is about services or goods to be provided by vendors or service providers. Each service provider, such as a take away restaurant, has got a terminal system 2, in the following in short called box for simplicity due to the close visual box-like resemblance in a typical embodiment, for communication from and to the CountryHandlerService 1 and for user interaction. The data communication between the terminal unit 2 and the first server or first group of servers with CountryHandlerService 1 is achieved via a wireless data network 7, for example the GPRS (General Packet Radio Service) network, for wireless data transmission between a server for a mobile network provider 5 and the terminal unit 2. The server for the mobile network provider 5 typically receives the data to be sent to the mobile unit 2 via a ground based network 4. The software system on a number of servers is in general explained below in more detail in connection with FIG. 1 and FIG. 2. The first software program, CountryHandlerService 1, with a first database 15 is used to handle all the service and goods related information for the client, whereas a second software program, the BoxHandlerService 3 on a second server or a second group of servers with a connected second database 14, called Jupiter Database in the drawing, is used to handle the commands for the configuration and for transmission of any information to and from the terminal units 2 via the wireless data network 7.

The box 2 is configured for receiving configuration data via the wireless data network 7, for example the GPRS (General Packet Radio Service) network, such that the database in the box 2 and the complete functioning can be transmitted to the box via the wireless network 7.

This implies that a box 2 can be placed in a restaurant and started and may, as soon as a wireless connection is established, be configured in relation to the intended use via the wireless net, for example for displaying orders at a take away restaurant. The same box may be reconfigured from time to time via data transfer to and from the box via the wireless data network 7. Such a reconfiguration may imply a completely different application, for example, the box 2 may change from displaying food orders in a restaurant to display requests for appointments at a hairdresser. According to the invention, this results in great flexibility of the box and its application without the need of technical support on site. This is a great advantage in countries, where expenses for technicians are large, for example because of large distances between vendors of certain services or where the infrastructure generally is not so good.

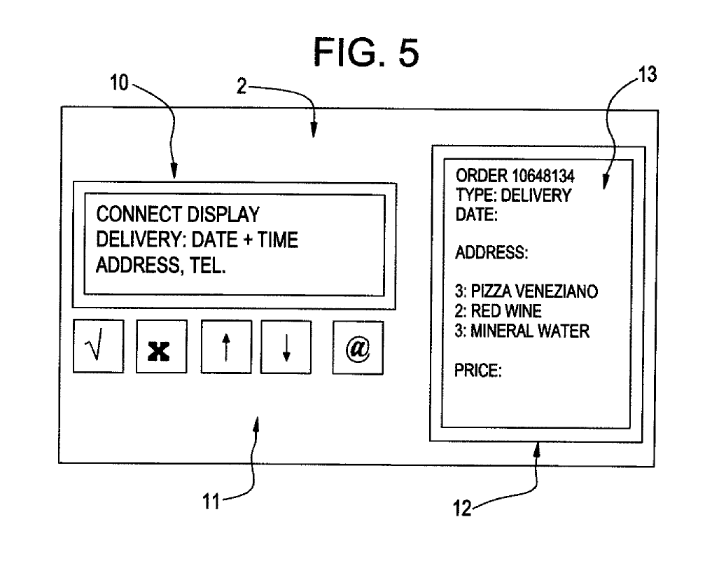

It should be noted that the term box for the terminal unit 2 is used because the preferred embodiment of the invention implies a simple designed box, for example as illustrated in FIG. 5, without any complicated appearance to the vendor. However, within the scope of the claims, a terminal unit of other technical design, for example, with a PC appearance could be used as well. Thus, the term box is not meant to limit the invention in any way, even though the simple box appearance of the terminal unit with only a few, for example less than ten, buttons for manual command input or manual data input, a single display and optionally a printer is the preferred solution.

A wireless network as the GPRS network 7 has a number of advantages. It is present as a service in a large number of countries and it has the necessary band width for data transmission in contrast to a GSM network. In addition, there is no requirement for installation of a physical telephone/Internet line such as ISDN or ADSL, which are dedicated lines. For the latter, firewalls may imply difficulties for the correct transmission of data.

The box 2 may be programmed to contain a number of methods that are autonomous but which can be used as series of methods. For example, a first method may display a message, a second method may print a message, a third method may store a menu line in a certain index, the fourth can send an SMS message (Short Message System). All method are simple as such, but a series of methods in a predetermined sequence may appear rather complex. By storing the methods as unrelated and relating them in a sequence as desired, a high flexibility is achieved, especially, when additional methods are implemented as an update.

Also, via the wireless network 7, the menu structure in the box 2, a selection of the desired language, and a provision of a correct size of displayed messages may be transmitted to the box. A change of such a configuration is also achieved via the wireless network 7. The only intrinsic property of the box is the ability to search for a wireless network and attempt to connect to a central server. All other configuration can be supplied through the wireless network.

During the design of a system according to the invention, a number of challenges were experienced. The goal was to build and deploy a system meeting a number of requirements. It should include a tier architecture and should further imply ease of distribution on at least two servers, ease of surveillance, easy maintenance and imply a run-time-safe environment. These points are discussed in detail in the following in connection with FIG. 1 and FIG. 2 showing a deployment diagram for a system according to the invention.

In the deployment diagram, one software program, the BoxHandlerService 3 on one or more servers takes care of sending and receiving data to and from the boxes. The corresponding service is connected to a database 14, called Jupiter, containing information about all known boxes 2 regardless of the country, where the boxes are situated. The determination of which order related data that are to be send to which boxes is performed in software programs, CountryHandlerServices 1, that are related either a single country, like the UK, or to a number of countries, for example Denmark (DK), Iceland (IS), and Norway (NO). The examples of the countries and the grouping are for illustration only and not limiting the invention in any way. The services are provided on one or more physical server locations in the countries, which also update various country-databases 15 regarding orders, restaurants, logfiles and transmitting new orders, etc.

Another software program, the BoxHandlerService, may be run on one or more central servers, as well as the country-dependent or region-dependent CountryHandlerService routines may be run on servers in the different countries. However, this is not strictly necessary. Communication between the different servers may be achieved via the Internet implying Extended Markup Language (XML). In future versions, inclusion of Simple Object Access Protocol (SOAP) is considered.

A web administration 6 may have access to the databases 14, 15 and to the software programs.

### Tier Architecture

The different services were advantageously kept low-coupled to improve scalability—that speaks in favour of a 3 tier client-server structure, which means that all incoming messages must pass through a gateway that decides which CPU (or server) has the resources to treat an incoming message. This architecture is easy to maintain but difficult to build and debug because of the complex structure.

Another way of distributing CPU cycles can be done by placing an SQL server (Structured Query Language—server) on a different CPU than the CPU used to handle the incoming and outgoing messages. The latter is illustrated in FIG. 2. This favours an easy-to-overlook system without loosing the possibility to scale the system on several servers. This approach was chosen because of the relatively tight time schedule and because it is an approach which decouples the system enough to scale the system upwards to at least several hundreds of boxes.

### Maintenance:

In the setup, it was chosen to decouple the country services from the tables that contain message queues and logs. It was decided that queues and information related to all boxes 2 were placed in a separate database 14 that received messages from all countries. In the individual countries, only the IMEI (International Mobile Equipment Identity) numbers of the boxes 2 at the service providers is stored in connection with the provided service or goods. The box-specific information is only stored in one central database, common for all countries. This database 14 is called the Jupiter database in the deployment diagram. All countries have a service connected that pushes messages onto this common database for the BoxHandlerService. This principle eases maintenance of a single country and avoids difficulties with incoherent database design in the various countries.

### Surveillance

All services will have a surveillance routine 16—a so-called Watchdog—connected which monitors that all services are running properly. In case of a breakdown, the watchdog 16 will try to restart the service and report the failure into an error log. All watchdogs are built to report into the Jupiter database, which gives an excellent overview of all running countries in case of a major breakdown.

### Runtime-Safe Environment

A service may be placed on the same server as the database to which it provides data. The advantage is to avoid a situation where the services cannot reach the database that it needs to update queues and logs. Communication with other servers is achieved by sending and receiving XML messages—no connection string or SQL server instance which other servers depend on will be available to these services

All messages throughout the system are pushed through to servers to avoid delays in data transmission. The timeout handler 17 will pull information from the queue and check for timeouts on the items stored in the queue

The diagram is explained in more detail in the following. The various responsibilities as illustrated in FIG. 2 are placed like this:

### Service: CountryHandlerService;

Interface ICountry_Transmitter; Pulls services from country database and transmits to JupiterIn
Interface ICountry_Incoming; Retrieves incoming messages from JupiterOut and stores log events and status notifications into country-specific DB

### Service: BoxHandlerService

IBox_Incoming; Retrieves incoming messages from MsgServers, which is a message handling program in connection with the wireless network and stores log events into Jupiter DB
IBox_Transmitter; Pushes messages to MsgServers
The BoxHandlerService also supports the logic for converting between XML and delimited string (and vice versa)

It should be noted that in practice, the transmission is performed in the following way. Even though all commands are stored in side the Jupiter database 14, a command is not send directly from the Jupiter database to the box 2, because that would imply that orders are send from one place, namely from the database 15 of the CountryHandlerService 1 and configuration commands from a second place, namely from the Jupiter database 14 of the BoxHandlerService 3. Therefore, every command from the Jupiter database 14 is send via a detour through the CountryHandlerService 1, as any transmission, this way, is always initiated though the CountryHandlerService 1.

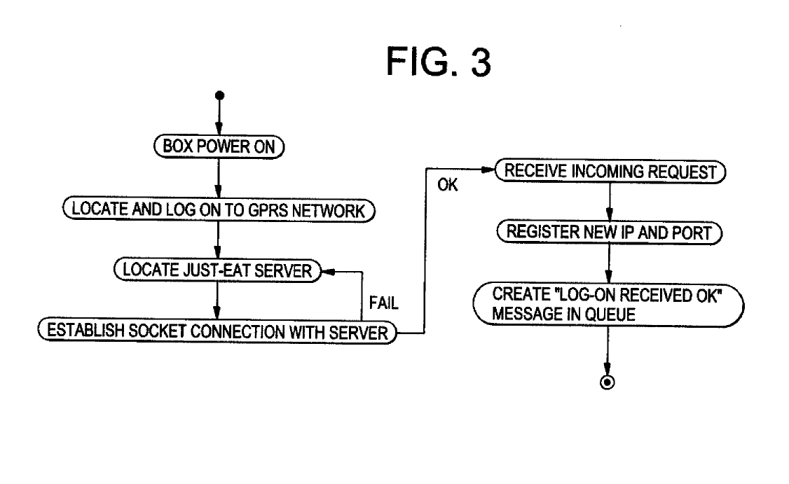

When a box 2 is powering on, it will automatically perform a number of steps as illustrated in FIG. 3 in order to receive messages from the BoxHandlerService 3. The box 2 typically starts with a self-test which after successful completion is followed by initialisation of the GPRS module taken into account a valid SIM card. The grant of an IP address on the network completes this step.

After connection to the GPRS network, the box 2 will attempt to locate the BoxHandlerService 3 through an Internet connection in dependence of the information regarding the location of the BoxHandlerService as stored in the box memory. If a BoxHandlerService responds to the request of the box, the BoxHandlerService will receive the incoming request and parse the transmitted message. This message contains information about IP-number, port number and also the IMEI (International Mobile Equipment Identity) identification code for the box 2 initiating the request. If the message is acceptably parsed, the new IP number and port number is saved in the database 14 for future reference to this particular box.

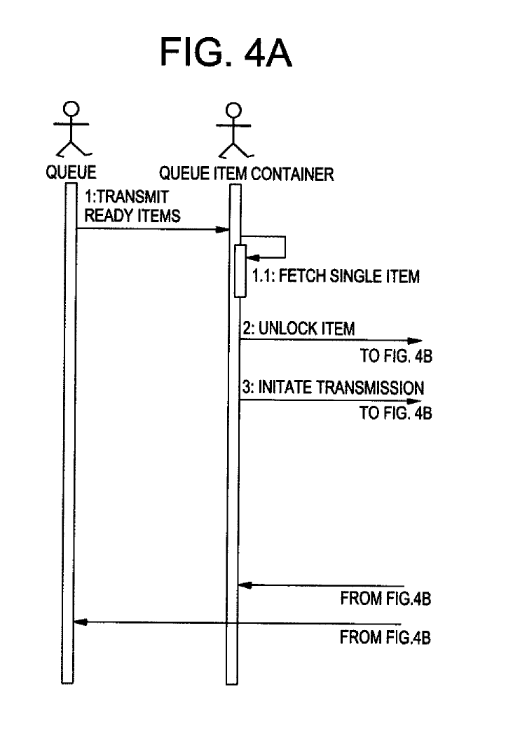

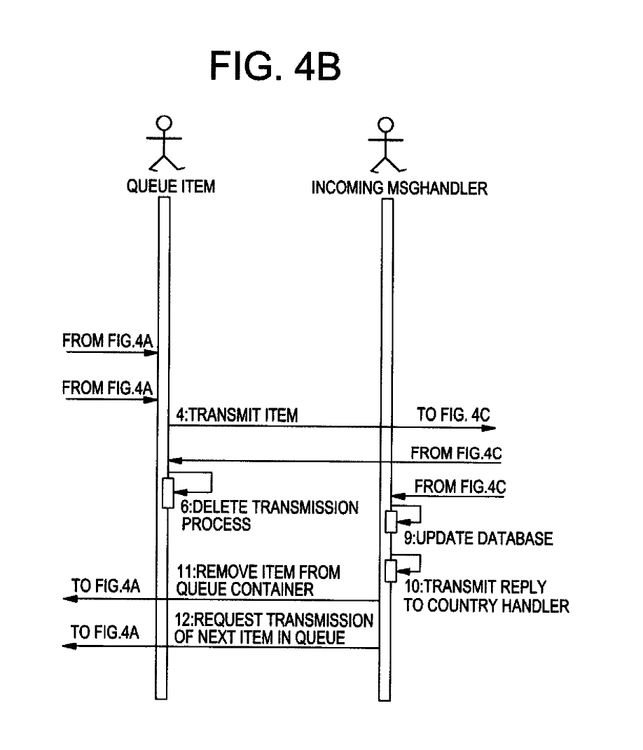

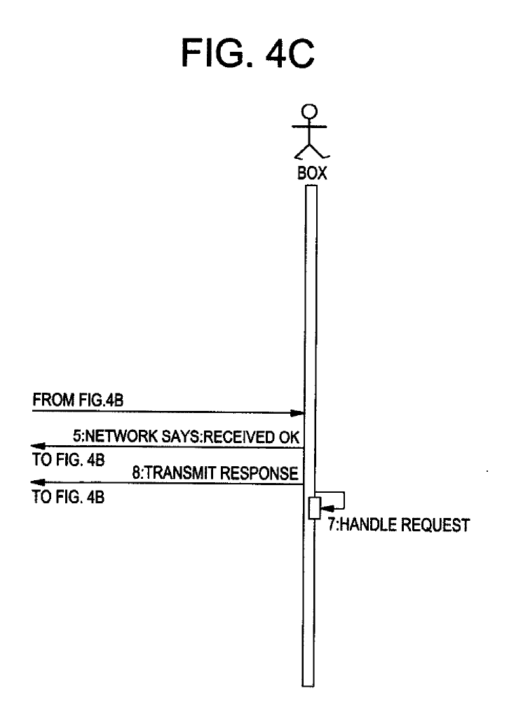

A message is placed in the queue for transmission to the box 2 in order to acknowledge the registration of the box 2. The message is not transmitted instantaneously but placed in the Queue and is first sent, once a special serviced, namely the QueueItemContainer as explained in FIG. 4, fetches the message and initiates transmission. The state machine of the box finishes the logon procedure, once this message is received.

FIG. 4 illustrates different programmed object oriented routines, namely Queue, QueueItemContainer, QueueItem, IncomingMsgHandler that are used for the communication with the box. The service Queue comprises all QueueItemContainers, one for each registered box. A single QueueItemContainer contains the number of messages to be sent to a specific box. QueueItem holds information about the single message for example a delimited string, and handles the transmission. IncomingMsgHandler concerns the responds from the box.

The transmission of a queue item is explained in the following. The implementation of the design enforces a message transmittal which in principle is the same for all messages that one could possibly send to a box 2. The diagram in FIG. 4 illustrates the flow of a message being transmitted—that could be either a request for the box 2 to play a melody or a request to download new firmware—the flow will in all cases be the same in principle.

When transmitting queue items to the database, an object called Queue first adds items to a container named QueueItemContainer. This object holds references to objects meant for the same box—for example a Queue can at any point in its life cycle hold 8 messages for box #1 in QueueItemContainer A, 6 messages for box #2 in QueueItemContainer B, 13 messages for box #3 in QueueItemContainer C etc. Adding messages to the QueueItemContainers is handled elsewhere—this diagram only explains how existing items in the container is forwarded once at time to the box.

1. The Queue contains a number of QueueItemContainers of which each is capable of cycling through all messages. The Queue loops through all QueueItemContainers at a given interval, for example twice per second, commanding each container to fetch the first item
2. The item will be unlocked in dependence of predetermined criteria such that only one message is sent at a time.
3. If it is not already in transmission, an order will be issued to start transmission
4. The item will then be transmitted to a box if possible.
5. The network responds with a message that the item is delivered at the right address. Note that this is only an indication to the box that a message has arrived—not that the box has completed any requested method invocation.
6. The response from the network for a correct delivery leads to a removal of the order for a transmission process from the queue.
7. Under normal circumstances, the box will handle the request after arrival of a message.
8. The box will reply with an answer, for example OK or with a time and a date if the handling could be performed, or respond with an error message, if the box was unable to process the method or the data in the message.
9. In accordance with the returned message from the box, the database is updated, and
10. A reply is transmitted to the CountryHandlerService as illustrated in FIG. 2.
11. The Item is then removed from the QueueItemContainer and the next item in the Queue is requested for transmission to the box.

In the case that the box is not responding, a time-out routine will terminate the waiting for a response from the box after a certain time, for example some seconds. If no response is received, or an error message is received, it is noted that the box is not responding properly and a corresponding message is sent to the CountryHandlerService. Furthermore, the box may removed from the network through software routines such that a new log-on is necessary for the box in order to continue or reinstate communication. Remaining messages for the box in the queue are removed from the container. They may at a later stage be provided again upon command from the CountryHandlerService.

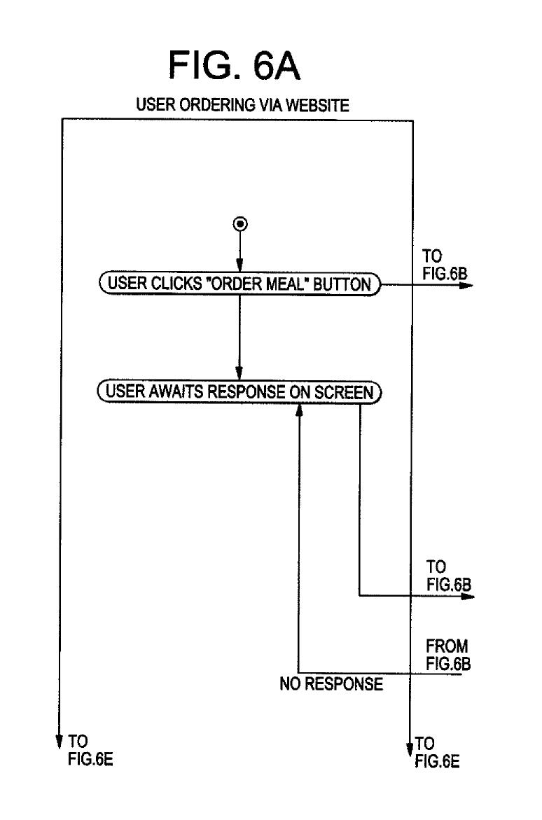

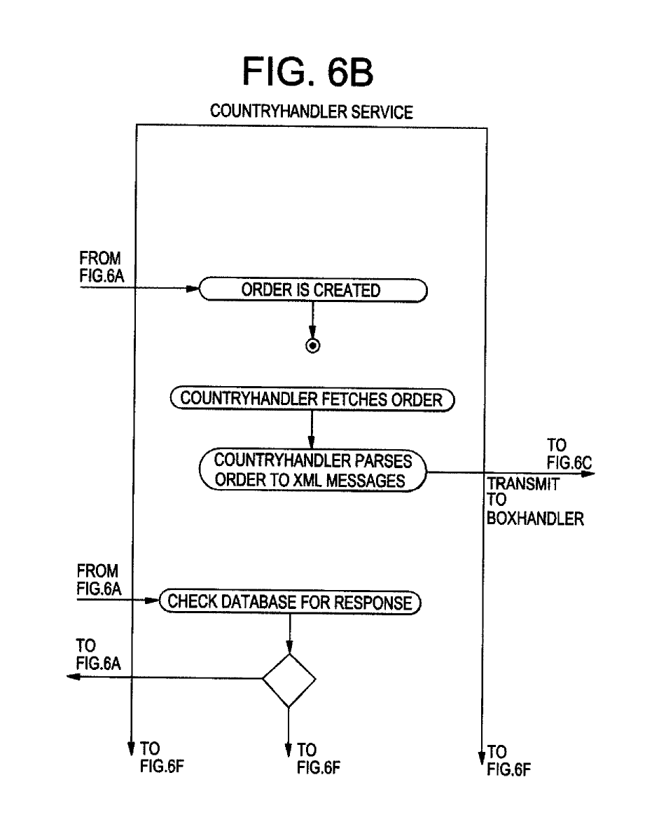

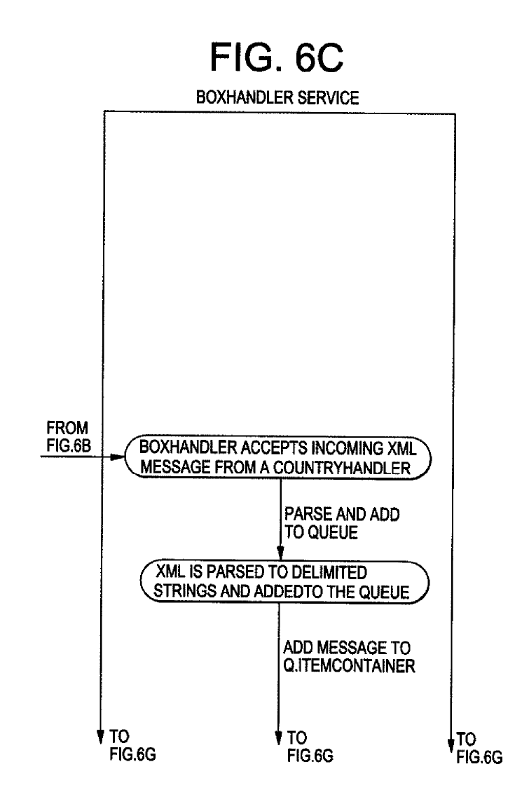

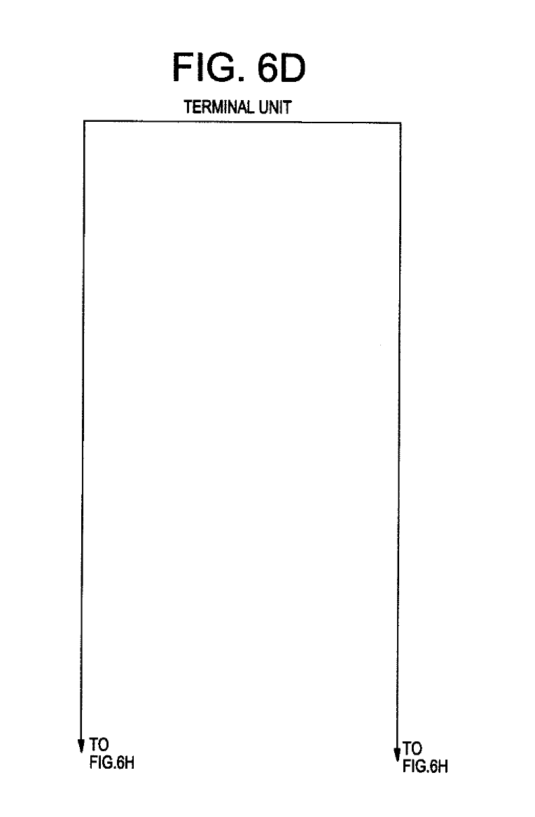

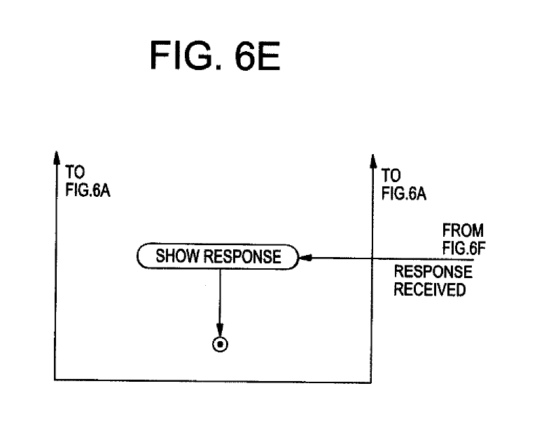

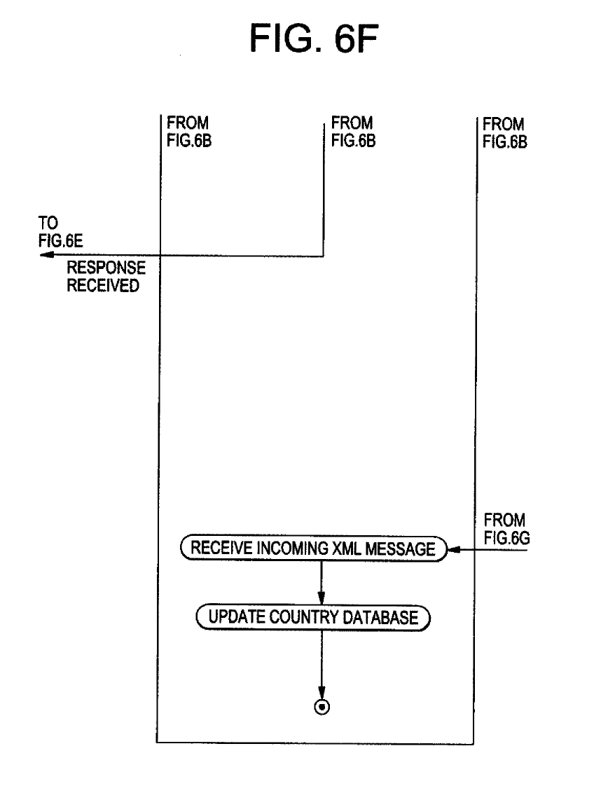

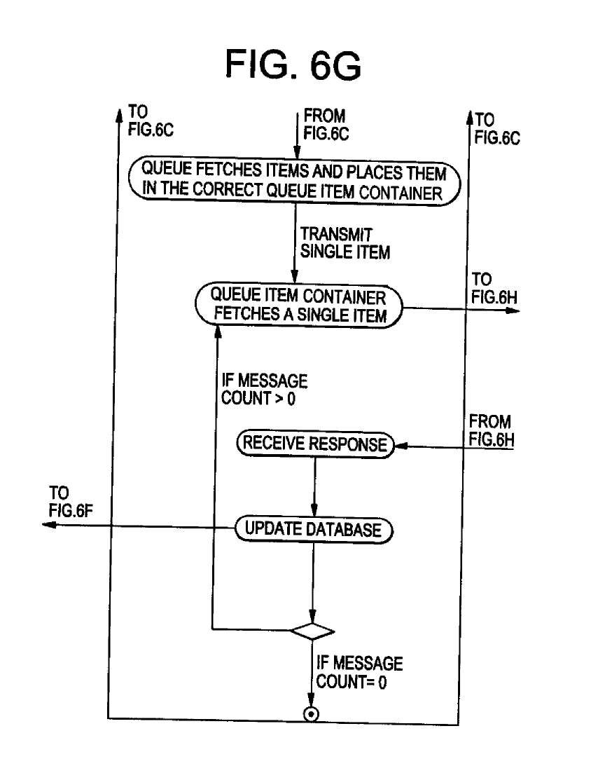

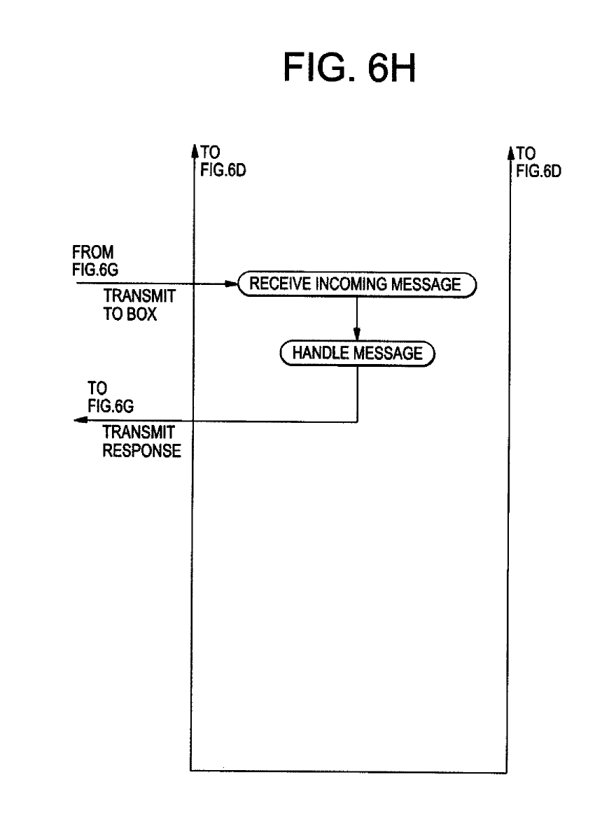

The order flow as seen from the user is illustrated in FIG. 6, where FIG. 6a is the left part of the flow diagram and FIG. 6b is the right part thereof.

The box at the site of the vendor of services, food or other goods, has been developed to simplify and minimise all actions that are necessary from the vendor's site. The vendor does not need any technician for set-up, because the box upon a simple power-on performs all the steps in collaboration with the GPRS network and the involved servers in order to start functioning. As not only the connection to the network is performed automatically but also the receipt of functions, for example the language and the performance routines, a box according to the invention is universal such that it can be used in different countries with different languages and for different service providers or vendors.

The system according to the invention may be used for ordering services or goods the way it is known for existing systems, where an ordering is performed over the Internet, for example on an Internet site, and services are picked up or delivered at the correct address. New boxes for new providers can easily be added to the system as well as boxes can be removed. All control: with the boxes is at the server's site.

A possible lay-out of the box is shown in FIG. 5. The box 2 comprises a display 10 for showing the personnel the order in short terms. It may also show the date, time and delivery address of the order. A small number of buttons 11 may be used for acceptance or denial of the order, for scrolling through the display and for other purposes. In addition, the box may contain a printing unit 12 for printing a paper list 13 of the goods, the price, the type of order, the delivery address and other related information.

As a summary, the following should be noted. The box is an autonomous terminal unit that is able to connect to a GPRS network or likewise data network, connect to a BoxHandler, receive and perform the commands from the software server. The box is configured to maintain the connection. If the box is not able to maintain the connection, for example due to a network failure or a server breakdown, a new log-on can be initiated by sending an SMS or other kinds of commands to the box with a server address after reestablishment of the function in the network or server. In order for the box to start searching for the right server with the right software program, the box may be configured upon powering up to automatically go into a waiting mode, where the box is waiting for an SMS revealing the server IP number and the port number to search for, and the network provider with a user name and a password, after which it connects correctly to the GPRS network in order to get connected to the server.

The BoxHandlerService handles communication from the boxes that request connection and handles communication to and from the boxes.

The CountryHandlerService is receiving orders, converting orders and other messages into correct commands, sending commands to the BoxHandlerService and other functions such as updating status of orders.

1. An ordering system for ordering services or goods, the ordering system comprising
a plurality of client computers (8) connected to a digital data network (9), the client computers (8) comprising means for receiving input from a client concerning orders;
a central server system comprising a first software program (1) and being connected to a first database (15) and to the digital data network (9), the first database (15) comprising digital data representing information about services or goods, service providers or good providers, the first software program (1) being configured for communication with the client computers (8) through the digital data network (9) for providing data from the first database (15) to the client computers (8) concerning offers for services or goods and for receiving digital data representing the orders for the services or goods, the first software program (1) being programmed to transmit an order to a service provider or goods provider in dependence of the order from a client;
at least one terminal unit (2) at the site for the service provider or good provider, the terminal unit (2) being configured for receiving orders from the first software program (1) and having means (10) for indicating the requested orders to the service or goods provider; and
a wireless digital data network (7) for transmitting data between the first software program (1) and the terminal unit (2) through a non-dedicated wireless line;
wherein the terminal unit (2) is programmed to perform the following steps in sequence automatically without involving action of a user:
searching for a wireless data network (7) and attempting to connect to a central server system (1, 3) upon powering on;
requesting configuration data from the server system (1,3) after connection to the wireless data network (7); and
performing a configuration for the actual functioning of the terminal unit (2) as a result of the receipt of configuration data.

2. An ordering system according to claim 1, wherein the digital data network (9) is the Internet.

3. An ordering system according to claim 1, wherein the wireless digital data network (7) is a GPRS network.

4. (canceled)

5. An ordering system according to claim 1, wherein the terminal unit (2) is programmed to execute the automatic search upon receipt of an SMS message with access data for the wireless network and the server system.

6. (canceled)

7. An ordering system according to claim 1, wherein the configuration data includes at least one from the following,
an indication for the language of text to be indicated on a display (10) of the terminal unit (2) as a response to an order receipt;
configuration of the terminal unit (2) for receipt and print of a daily order list in accordance with daily opening hours of the service or goods provider;
configuration of the terminal unit (2) to send an SMS to the ordering client for confirmation of the order, optionally the SMS including delivery time or pick-up time and price;
configuration of a menu structure for a user menu associated with a display (10) of the terminal unit (2); and
configuration of graphics for a display (10) of the terminal unit (2).

8. An ordering system according to claim 1, wherein the server system is configured with a three-tier client-server structure.

9. An ordering system according to claim 8, wherein the three tier client structure comprises
at least one terminal unit (2) connectable to a wireless network (7);
a first server or first group of servers with a first software program (1) programmed to provide information to clients, to receive orders from the clients for services or goods, and to transmit the orders to the terminal unit (2) and programmed to receive messages from the terminal unit (2) concerning possible execution of the order; and
a second server or a second group of servers with a second software program (3) configured to receive the orders through the digital data network (9) from the first server or first group of servers with the first software program (1), the second server or the second group of servers (3) being connected to the wireless data network (7) through a mobile network provider (5) and configured by the second software program to transmit (4) theses orders through the wireless network (7) to the terminal unit (2), the second server or second group of servers (3) also being configured to receive messages from the terminal unit (2) through the wireless network (7) and forwarding these messages to the first software program (1) on the first server or first group of servers.

10. An ordering system according to claim 9, wherein the server system is configured such that only the second software program (3) on the second server or second group of servers has access to a further central database (14) that contains information of and for all the registered terminal units (2) and which contains commands for configuration of the terminal units (2).

11. An ordering system according to claim 9, wherein the first server or first group of servers (1) comprises a number of servers in a number of countries with at least one server in each country.

12. An ordering system according to claim 9, wherein the first server or first group of servers and the second server or second group of servers being configured to use Extended Markup Language (XML) for communication over the digital data network and optionally also Simple Object Access Protocol (SOAP).

13. An ordering system according to claim 1, wherein the server system has a surveillance routine (16) programmed to restart at least parts of the system upon breakdown of the system and programmed to store a failure report in a log-file in a database (14, 15).

14. An ordering system according to claim 4, wherein the terminal unit (2) is programmed to automatically request configuration data from the server system (1,3) after connection to the wireless data network (7) and configured to perform a configuration for the actual functioning of the terminal unit (2) as a result of the receipt of configuration data.

15. An ordering system according to claim 5, wherein the terminal unit (2) is programmed to automatically request configuration data from the server system (1,3) after connection to the wireless data network (7) and configured to perform a configuration for the actual functioning of the terminal unit (2) as a result of the receipt of configuration data.
